(19) United States
(12) Patent Application Publication
(10) Pub. No.: US 2024/0249620 A1
(43) Pub. Date: Jul. 25, 2024

(54) MANAGEMENT SYSTEM AND TRAVELING CONTROL SYSTEM

(71) Applicants: Toyota Jidosha Kabushiki Kaisha, Toyota-shi (JP); KOMATSU LTD., Tokyo (JP)

(72) Inventors: Toru TAKASHIMA, Susono-shi (JP); Takahiro Okano, Chiryu-shi (JP); Shun Mizoo, Zama-shi (JP); Yusuke Nozawa, Atsugi-shi (JP); Takashi Hiranaka, Tokyo (JP); Kenta Osagawa, Tokyo (JP); Shota Konishi, Tokyo (JP)

(73) Assignees: Toyota Jidosha Kabushiki Kaisha, Toyota-shi (JP); KOMATSU LTD., Tokyo (JP)

(21) Appl. No.: 18/417,608

(22) Filed: Jan. 19, 2024

(30) Foreign Application Priority Data
Jan. 24, 2023 (JP) 2023-008529

(51) Int. Cl. G08G 1/0967; G08G 1/01; G08G 1/048

(52) U.S. Cl. CPC G08G 1/096725; G08G 1/0125; G08G 1/048

(57) ABSTRACT

A management system configured to manage a plurality of movable bodies that travels a travel region, including: a work plan generating device configured to generate a work plan of the plurality of movable bodies based on a run-through ability of each of the plurality of movable bodies and a road surface condition that is a condition of a road surface of the travel region.

### REFERENCE TO RELATED APPLICATIONS

This application claims priority from Japanese Patent Application 2023-008529 filed on Jan. 24, 2023. The entire content of the priority application is incorporated herein by reference.

### BACKGROUND ART

The present disclosure relates to a management system configured to manage a plurality of movable bodies and a traveling control system configured to control traveling of a movable body.

Japanese Patent Application Publication No. 2020-013537 describes that unevenness (potholes) is obtained as a condition of a road surface based on a behavior of a vehicle that travels a paved road and the road is repaired depending on a degree of deterioration of the road surface.

### DESCRIPTION

An aspect of the present disclosure is related to a technique of preventing a movable body from getting stuck.

According to the present disclosure, traveling of the movable body into a travel region is controlled or a work plan is generated, based on a road surface condition of the travel region and a run-through ability of the movable body. This enables the movable body to be less likely to get stuck in the travel region.

The objects, features, advantages, and technical and industrial significance of the present disclosure will be better understood by reading the following detailed description of embodiments, when considered in connection with the accompanying drawings, in which:

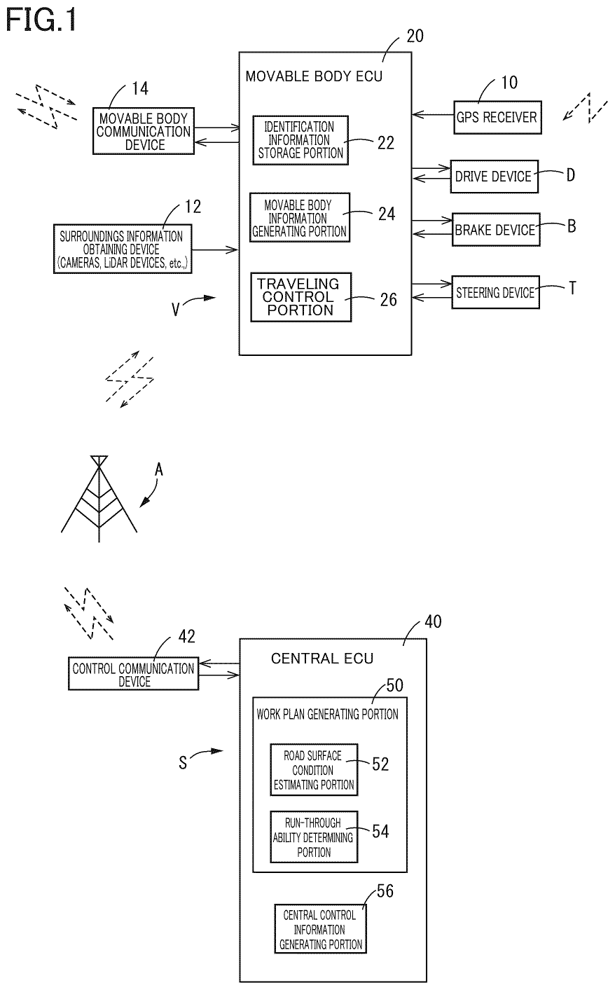

FIG. 1 is a view conceptually illustrating a whole management system according to a first embodiment of the present disclosure, the management system being also a traveling control system according to the first embodiment;

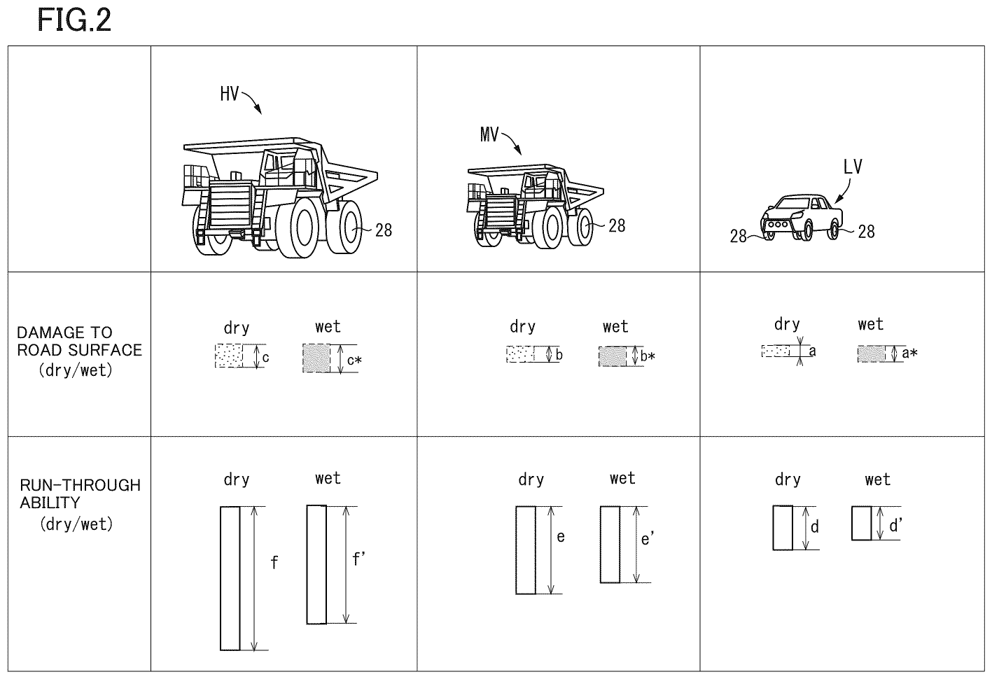

FIG. 2 is a view conceptually illustrating a run-through ability and damage to a road surface that is caused by each of movable bodies to be managed by the management system (to be controlled by the traveling control system);

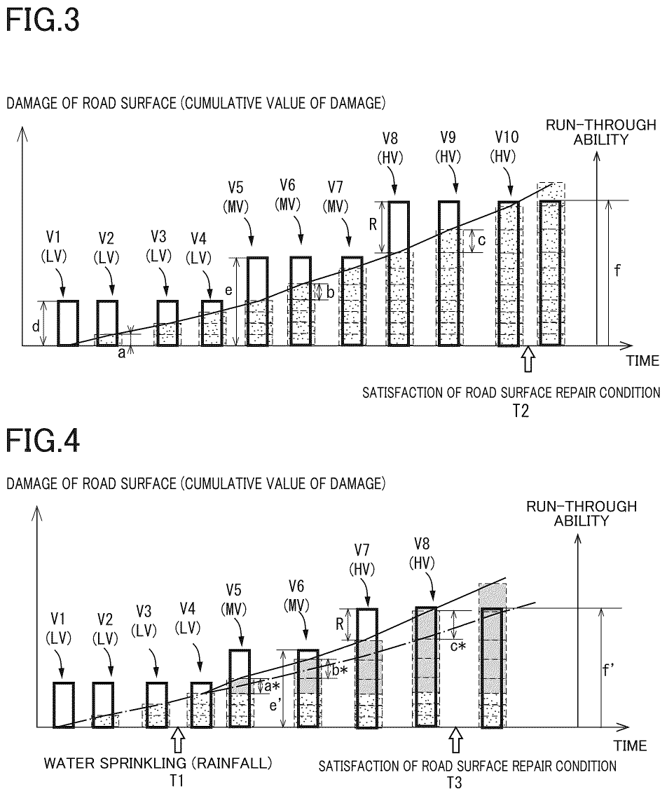

FIG. 3 is a view illustrating a relationship between a cumulative value of damage of a travel region where the movable body travels and a run-through ability of the movable body;

FIG. 4 is a view illustrating another relationship between the cumulative value of damage of the travel region where the movable body travels and the run-through ability of the movable body;

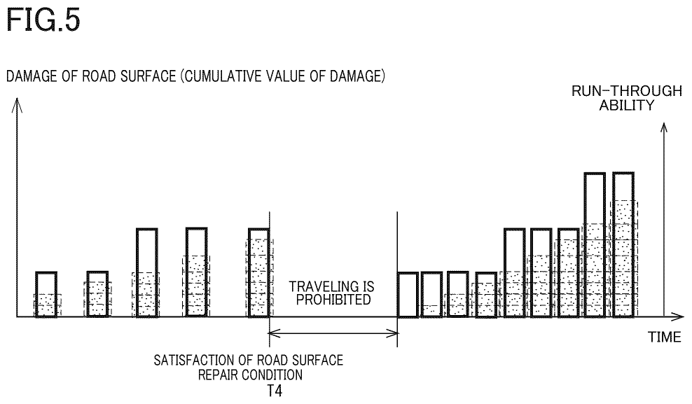

FIG. 5 is a view illustrating still another relationship between the cumulative value of damage of the travel region where the movable body travels and the run-through ability of the movable body;

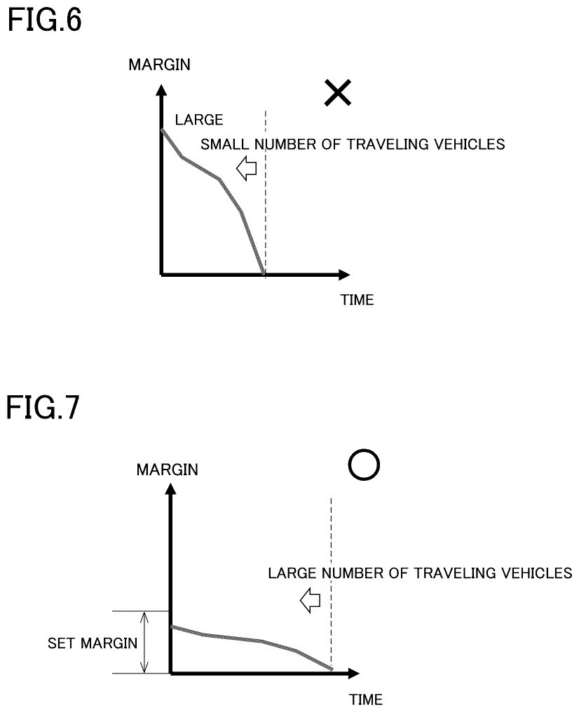

FIG. 6 is a view illustrating one example of a change with a lapse of time of a margin of the run-through ability with respect to the cumulative value of damage of the travel region;

FIG. 7 is a view illustrating another example of a change with a lapse of time of the margin of the run-through ability with respect to the cumulative value of damage of the travel region;

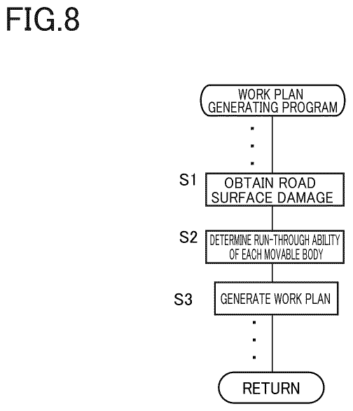

FIG. 8 is a flowchart of a work plan generating program stored in a storage of a central ECU of the management system;

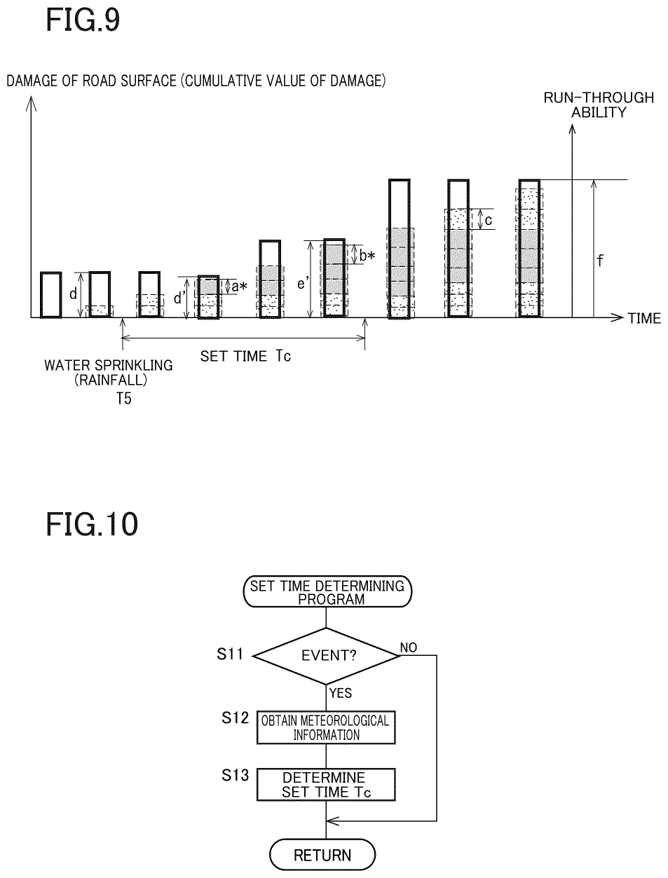

FIG. 9 is a view illustrating another relationship between the cumulative value of damage of the travel region where the movable body travels and the run-through ability of the movable body;

FIG. 10 is a flowchart of a set time determining program stored in the central ECU of a central control device of the management system;

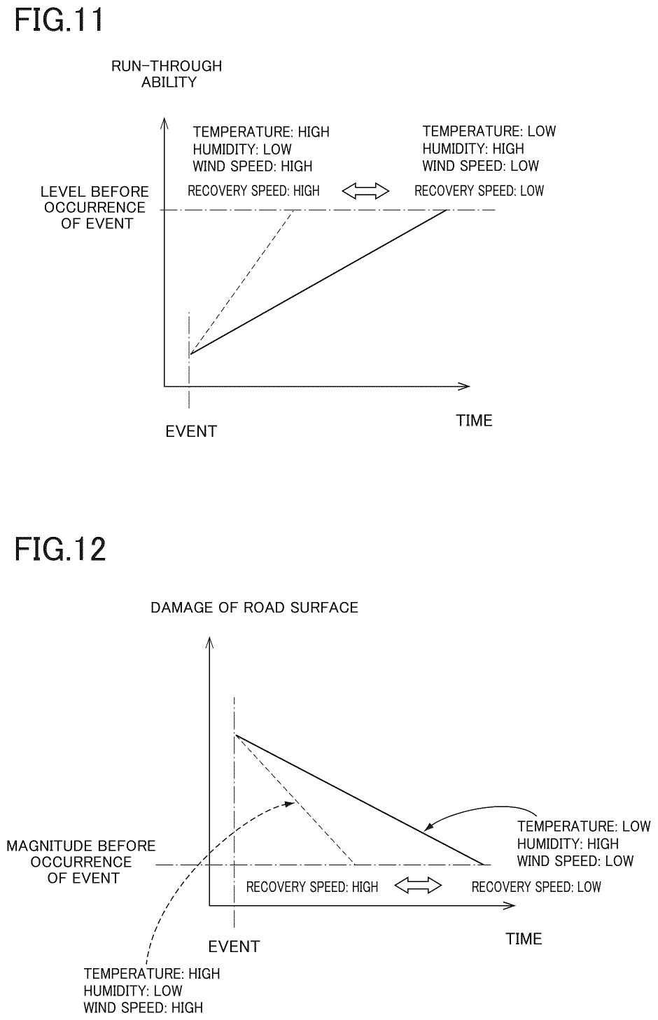

FIG. 11 is a run-through ability determining map;

FIG. 12 is a map for determining damage to the road surface;

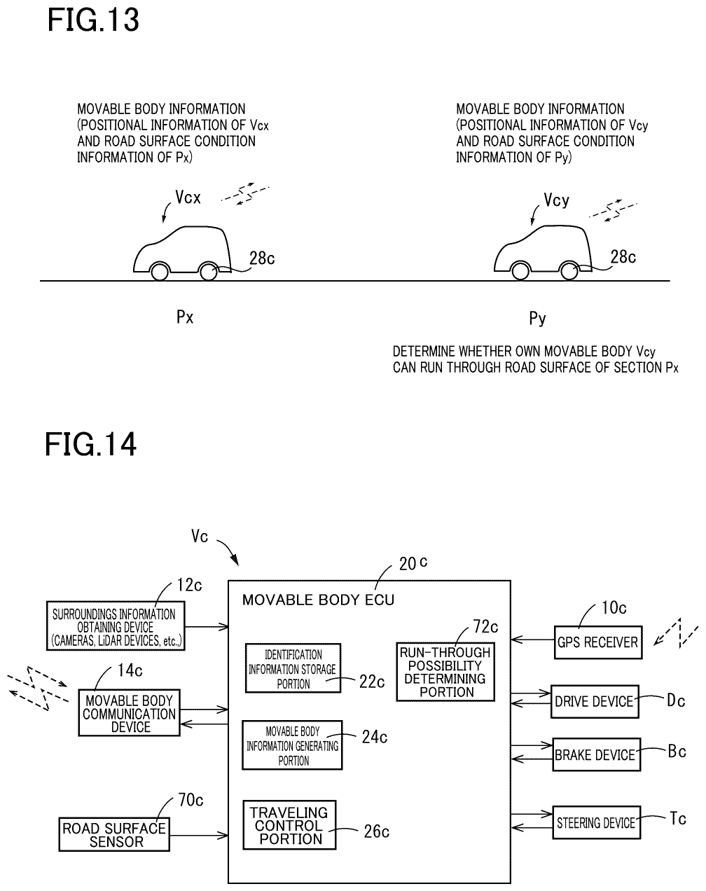

FIG. 13 is a view conceptually illustrating a plurality of movable bodies to be controlled by a traveling control system according to a second embodiment of the present disclosure; and

FIG. 14 is a view conceptually illustrating the traveling control system.

Referring to the drawings, there will be described below a management system according to one embodiment of the present disclosure. The management system is also a traveling control system according to one embodiment of the present disclosure.

### First Embodiment

As illustrated in FIG. 1, the management system of the present embodiment includes a central control device S communicable with a plurality of movable bodies V that works in mimes, for instance, and one or more antennas A. The movable bodies V and the central control device S perform wireless communication directly or via the antenna A.

As illustrated in FIG. 2, the movable bodies V include one or more large-sized movable bodies (such as heavy machines or large-sized dump trucks) HV, one or more mid-sized movable bodies (such as mid-sized dump trucks) MV, and one or more small-sized movable bodies (such as small-sized dump trucks) LV. In the present embodiment, the large-sized movable body HV, the mid-sized movable body MV, the small-sized movable body LV will be simply referred to as the movable body V individually without distinguishing them where appropriate.

The large-sized movable body HV is a movable body whose weight is greater than a first set weight. (Hereinafter, the weight refers to: a gross weight that is a sum of the weight of the movable body and a load weight; or the weight of the movable body itself.) The mid-sized movable body is a movable body whose weight is not greater than the first set weight and greater than a second set weight that is smaller than the first set weight. The small-sized movable body is a movable body whose weight is not greater than the second set weight.

Each of the large-sized movable body HV, the mid-sized movable body MV, and the small-sized movable body LV may be an automated traveling movable body V that travels based on a command from the central control device S or may be a manual driving movable body V capable of traveling by a driver's driving operation.

The movable bodies V travel a predetermined region in the work. The travel region may be the entirety of the predetermined region or may be part of the predetermined region.

As illustrated in FIG. 1, each movable body V includes a drive device D for driving the movable body V, a brake device B for braking the movable body V, a steering device T for steering steerable wheels of the movable body V, a global positioning system (GPS) receiver 10, a surroundings information obtaining device 12, a movable body communication device 14, and a movable body ECU 20.

The drive device D may include one or more electric motors each functioning as a drive source and connected to a plurality of drive wheels among a plurality of wheels 28. Further, a drive circuit (such as an inverter) is provided so as to correspond to the electric motor. By controlling the drive circuit, the drive force applied to the drive wheels is controlled, and the drive force applied to the movable body V is automatically controlled.

The drive device D may include an engine in addition to or in place of the electric motor.

The brake device B may include: friction brakes each provided for a corresponding one of the wheels 28 (FIG. 2) to decrease rotation of the wheel 28 by pressing friction engagement members against a brake rotary body that is rotatable integrally with the wheel 28; and a pressing force control actuator for controlling a pressing force of each friction brake. By controlling the pressing force control actuator, the pressing force of the friction brakes provided for the respective wheels 28 is controlled, so that the braking force applied to each wheel 28 is controlled and the braking force applied to the movable body V is automatically controlled. Regenerative braking may be applied to the wheels 28 by braking of the electric motor of the drive device D.

The steering device T steers the steerable wheels among the wheels 28. The steering device T includes a pair of tie rods connecting the right and left steerable wheels, a steering rod connecting the pair of tie rods, and a steering actuator provided for the steering rod. The steering rod is moved by the steering actuator in the width direction of the vehicle, so that the right and left steerable wheels are automatically steered.

The GPS receiver 10 receives signals from the GPS (e.g., the GPS signals). The GPS is one example of a global navigation satellite system (GNSS). Based on the GPS signals, the position of an own movable body that is the movable body V is obtained. Based on the GPS signals, the three-dimensional position of the own movable body V represented by the latitude, the longitude, and the altitude or two-dimensional position of the own movable body V represented by the latitude and the longitude may be obtained.

The surroundings information obtaining device 12 includes a plurality of cameras, a plurality of light detection and ranging or laser imaging detection and ranging (LiDAR) devices. The surroundings information obtaining device 12 recognizes an object present in the surroundings of the own movable body V that is the movable body V and obtains a relative positional relationship between the object and the own movable body V.

The movable body communication device 14 wirelessly transmits movable body information generated by the movable body ECU 20 and receives central control information that is information wirelessly transmitted from the central control device S.

The movable body ECU 20 is constituted mainly by a computer. There are connected, to the movable body ECU 20, the drive circuit of the drive device D, the pressing force control actuator of the brake device B, the steering actuator of the steering device T, the GPS receiver 10, the surroundings information obtaining device 12, and the movable body communication device 14. The movable body ECU 20 includes an identification information storage portion 22, a movable body information generating portion 24, and a traveling control portion 26.

The identification information storage portion 22 stores identification information set for the own movable body V that is the movable body V. Mutually different identification information is given to the large-sized movable bodies HV, the mid-sized movable bodies MV, and the small-sized movable bodies.

The movable body information generating portion 24 generates movable body information including: movable body positional information obtained based on the GPS signals and representing the position of the own movable body V; and the identification information of the own movable body V. The generated movable body information is output to the movable body communication device 14. The movable body communication device 14 transmits the movable body information.

The traveling control portion 26 controls traveling of the own movable body V by controlling the drive device D, the brake device B, and the steering device T. In the present embodiment, the traveling control portion 26 controls the drive device D, the brake device B, the steering device T based on a control command included in the central control information received by the movable body communication device 14 and transmitted from the central control device S.

The central control device S includes a central ECU 40 constituted mainly by a computer and a control communication device 42 connected to the central ECU 40. The central ECU 40 includes a work plan generating portion 50 and a central control information generating portion 56. The work plan generating portion 50 includes a road surface condition estimating portion 52 and a run-through ability determining portion 54.

The control communication device 42 wirelessly transmits the central control information generated by the central control information generating portion 56 and receives the movable body information wirelessly transmitted from the movable body V.

The central control information generating portion 56 generates the central control information including control command information to the movable body V and identification information indicating the movable body V that is a control target. The generated central control information is output to the control communication device 42 and is wirelessly transmitted by the control communication device 42.

The work plan generating portion 50 generates, for each movable body V, a traveling plan in a work plan. The traveling plan includes a traveling (departure) order of the movable bodies V in which the movable bodies travel, a road surface repair timing, etc. The work plan generating portion 50 generates the traveling plan based on a road surface condition that is a condition of the road surface of the travel region estimated by the road surface condition estimating portion 52 and a run-through ability of each movable body V determined by the run-through ability determining portion 54.

The road surface condition estimating portion 52 estimates the road surface condition that is the condition of the road surface of the travel region where the movable bodies V travel. As described above, the travel region may be each of sections of the region that are obtained by dividing the region where the movable bodies V travel in the work or may be the whole region where the movable bodies V travel in the work.

The road surface condition includes a road surface unevenness condition and a condition of a water content of the road surface (i.e., whether the road surface is in a dry condition or a wet condition). The road surface unevenness condition deteriorates as the movable body V travels. In a case where the travel region is a dirt road, ruts are formed, namely, unevenness (protrusions and recesses) is generated, as the movable body V travels. The degree of the unevenness is higher when the movable body whose weight is greater than a set weight travels than when the movable body whose weight is less than the set weight travels, and the degree of the unevenness increases with an increase in the number of the movable bodies V that travel. The set weight generally refers to a certain weight and may be the first set weight or the second set weight indicated above or may be other weight. The high degree of the unevenness means a great height difference between the protrusions and the recesses. For instance, the high degree of the unevenness means deeper recesses and/or higher protrusions. The dirt road refers to a region where the road surface is formed of soil or mud.

In the present embodiment, the degree of the unevenness generated on the road surface due to traveling of one movable body V will be referred to as “the magnitude of the damage received by the road surface (from one movable body V)” or “the magnitude of the damage to the road surface caused by one movable body V”. The magnitude of the damage received by the road surface from one movable body is determined based on the weight of the movable body V and the condition of the water content of the road surface, for instance.

Specifically, the magnitude of the damage to the road surface caused by traveling of one movable body V is greater when the movable body V whose weight is greater than the set weight travels than when the movable body V whose weight is smaller than the set weight travels. The magnitude of the damage to the road surface caused by traveling of one movable body V is greater when the water content of the road surface is greater than a set content than when the water content of the road surface is smaller than the set content. That is, the magnitude of the damage received by the road surface from one movable body is greater when the road surface is wet (muddy) than when the road surface is dry if the same weight of the movable bodies V travel. In a case where an event, such as rainfall, snowfall, or water sprinkling for preventing generation of sand dust, occurs, for instance, the magnitude of the damage received by the road surface from one movable body V is greater after occurrence of the event than before occurrence of the event. In a case where the weather gets better after rainfall or snowfall or after water sprinkling is performed, the road surface gradually becomes dry. Thus, the damage received by the road surface from one movable body gradually becomes small. The water sprinkling is usually performed when a predetermined water sprinkling condition is satisfied. For instance, the water sprinkling is regularly performed or performed when the degree of dryness of the road surface is higher than a set degree.

The condition of the water content of the road surface is estimated based on the situation of the event such as water sprinkling, rainfall, or snowfall, the meteorological information (including information by weather forecasting) after occurrence of the event, etc. The water content is greater when the event occurs than when the event does not occur. The water content after occurrence of the event is determined based on the meteorological information. For instance, the water content of the road surface becomes small earlier when temperature is high and wind volume is large than when temperature is low and wind volume is small, respectively. The road surface condition estimating portion 52 of the present embodiment estimates, as “the condition of the water content of the road surface”, the water content itself of the road surface. The road surface condition estimating portion 52 may be configured otherwise. For instance, the road surface condition estimating portion 52 may estimate whether the condition of the road surface is a condition in which the water content is greater than the set content or whether the condition of the road surface is a condition in which the water content is not greater than the set content. In a case where the event does not occur, the water content may be estimated to be not greater than the set content. In a case there the event occurs, the water content may be estimated to be greater than the set content.

In the present embodiment, the magnitude of the damage to the road surface of the travel region caused by one movable body V is predetermined for each movable body V, as illustrated in FIG. 2. When the small-sized movable body LV travels, for instance, the damage is smaller than that when the mid-sized movable body MV or the large-sized movable body HV travels (a<b<c). When the road surface is wet (i.e., when the water content is greater than the set content), the damage to the road surface caused by one movable body is greater than that when the road surface is dry (i.e., when the water content is not greater than the set content) (a<a*, b<b*, c<c*).

The road surface unevenness condition of the travel region is estimated by cumulating (adding) the damage received by the road surface from one movable body in each of a case where the road surface is dry (FIG. 3) and a case where the road surface is wet (FIG. 4). This is because the degree of unevenness of the travel region deteriorates as the movable bodies V travel.

As illustrated in FIG. 4, the damage (b*) received by the road surface from one movable body V when the road surface is wet after water sprinkling or the like is greater than that when the road surface is dry (b*>b). Thus, as apparent from a comparison between the solid line (indicating the cumulative value of the damage received by the road surface when the road surface is wet) and the long dashed short dashed line (indicating the cumulative value of the damage received by the road surface when the road surface is dry), the increase gradient of the cumulative value of the damage received by the road surface is greater and the deterioration gradient of the road surface unevenness condition are greater when the event occurs than when the event does not occur.

The run-through ability determining portion 54 determines the run-through ability of each of the movable bodies V. The run-through ability means a characteristic that the movable body can run through a rough uneven road (dirt road) without getting stuck. The run-through ability is determined based on characteristics of the movable bodies V and the condition relating to the water content of the road surface.

The characteristic of each movable body V includes the weight of the movable body V, the ability of the drive device D of the movable body V, the rigidity (strength) of the movable body V, the vehicle height of the movable body V, the size of the wheel 28. For instance, the run-through ability of the movable body V whose weight is larger than the set weight is higher than that of the movable body V whose weight is not larger than the set weight. The run-through ability of the movable body V whose vehicle height is greater than a set vehicle height is higher than that of the movable body V whose vehicle height is not greater than the set vehicle height. The run-through ability of the movable body V having the wheel 28 whose diameter is greater than a set diameter value is higher than that of the movable body V having the wheel 28 whose diameter is not greater than the set diameter value. The run-through ability is higher when the power of the drive device D is greater than a set power than when the power of the drive device D is not greater than the set power. The run-through ability is higher when the movable body V is four-wheel drive vehicle than when the movable body V is a two-wheel drive vehicle. In any case, the movable body with high run-through ability can run through the travel region in which the road surface condition is bad (such as the travel region in which the degree of the unevenness is high), as compared with the movable body with low run-through ability.

As illustrated in FIG. 2, the run-through ability of the large-sized movable body HV and the run-through ability of the mid-sized movable body MV are higher than that of the small-sized movable body LV (d<e<f). The run-through ability when the road surface is in the wet condition and the friction coefficient of the road surface is low is lower than that when the road surface is in the dry condition and the friction coefficient of the road surface is high (d>d′, e>e′, f>f′).

In the present embodiment, the run-through ability of each movable body V when the road surface is in the wet condition and the run-through ability of each movable body V when the road surface is in the dry condition are both predetermined and stored. Thus, the run-through ability of the movable body V is selected and determined to be one of the run-through ability when the road surface is in the wet condition and the run-through ability when the road surface is in the dry condition, based on the water content of the road surface, for instance.

The run-through ability of the movable body V is higher and the damage to the road surface caused by one movable body V is greater in a case where the weight of the movable body V is great than in a case where the weight of the movable body V is small. Thus, the damage to the road surface caused by the movable body with high run-through ability generally tends to be great, and the damage to the road surface caused by the movable body with low run-through ability generally tends to be small.

The run-through ability is represented by the road surface condition that can be run through, for instance. In a case where the run-through ability is higher than the run-through ability required for running through the road surface condition of the travel region, in other words, in a case where the level of the deterioration of the road surface condition that can be run through and that is determined based on the run-through ability is higher than the level of actual deterioration of the road surface condition of the travel region, the movable body V can run through the travel region.

The run-through ability is represented by a cumulative value of the damage received by the road surface (the road surface unevenness condition) in each of a case where the road surface is dry and a case where the road surface is wet, namely, in a case where the water content of the road surface is determined. When the run-through ability is higher than the cumulative value of the damage received by the road surface of the travel region, it is estimated that the movable body V can run through the travel region.

The traveling plan (the traveling order and the road surface repair timing) in the work plan is generated such that as many movable bodies V as possible can run through the travel region before the road surface repair is performed.

Each block indicated by the solid line in FIGS. 3-5 and 9 represents the run-through ability. Each block indicated by the dashed line in FIGS. 3-5 and 9 represents the damage received by the road surface from one movable body V. The entirety of the piled blocks represents the cumulative value of the damage received by the road surface.

In FIG. 3, the movable bodies V1-V10, each of which has the run-through ability greater than the cumulative value of the damage received by the road surface, can run through the travel region.

In FIG. 4, the event (such as rainfall or water sprinkling) occurs at time T1. Because the road surface becomes wet due to the event, the damage of the road surface is large and the run-through ability of the movable body V is lowered, as compared with when the event does not occur. In FIG. 4, the long dashed short dashed line indicates a change of the cumulative value of the damage when the event does not occur, and the solid line indicates a change of the cumulative value of the damage when the event occurs. It is apparent from FIG. 4 that the increase gradient of the cumulative value of the damage is greater when the event occurs. Further, the number of movable bodies (V1-V8) that can run through the travel region, namely, the number of movable bodies whose run-through ability is greater than the cumulative value of the damage, is smaller when the event occurs than when the event does not occur.

When a predetermined road surface repair condition is satisfied, the road surface is repaired by a dedicated vehicle for road surface repair (gradar), and the unevenness of the road surface is leveled. The road surface repair condition may be a case where it is estimated that there are no movable bodies V having the run-through ability that can run through the road surface condition. In FIG. 3, the road surface repair condition is satisfied at time T2. In FIG. 4, the road surface repair condition is satisfied at time T3.

The road surface repair condition may be a case where there is a request for causing the set number or more of the movable bodies V to travel within a set time. In FIG. 5, the road surface repair condition is satisfied at time T4. The road surface is repaired before the movable bodies V travel at high frequency, thus preventing a reduction in work efficiency.

A difference between the run-through ability and the cumulative value of the damage to the road surface is referred to as a margin R (FIGS. 3 and 4) when the movable body V can run through the travel region. The departure order (traveling order) of the plurality of movable bodies in the traveling plan is desirably determined such that the run-through ability is not excessive with respect to the road surface unevenness condition both when the road surface is dry and when the road surface is wet. In other words, the traveling plan is desirably generated such that the margin R is smaller than a set margin and greater than 0.

As illustrated in FIG. 6, when the movable body V with a great margin R travels at the beginning of traveling, in other words, when the movable body V whose run-through ability is excessive with respect to the road surface unevenness condition travels, the deterioration degree of the road surface unevenness condition, namely, the increase gradient of the cumulative value of the damage, increases. In this instance, the timing of satisfaction of the road surface repair condition (such as the case where there are no movable bodies V that can run through the travel region) is accelerated. This is not desirable.

In contrast, when the traveling plan is generated in a state in which the margin R is smaller than the set margin, namely, in a state in which the run-through ability is not excessive with respect to the road surface condition as illustrated in FIG. 7, many movable bodies V can run through the travel region before the road surface is repaired.

In FIGS. 3 and 4, the margin R may increase after having been decreased. It is considered that the increased margin R is not greater than the set margin.

In the present embodiment, the traveling plan is generated such that the small-sized movable body LV travels so as to precede the large-sized movable body HV. This suppresses the increase gradient of the cumulative value of the damage of the road surface, and the cumulative value is kept small for a long period of time. As a result, many movable bodies V can run through the travel region.

The work plan generating portion 50 executes a work plan generating program of a flowchart of FIG. 8.

At Step 1, the damage received by the road surface from each movable body V is obtained for each of the plurality of movable bodies V. Step 1 will be hereinafter abbreviated as S1. Other steps will be similarly abbreviated. At S2, the run-through ability of each movable body V is determined. At S3, the traveling plan (including the traveling order, the road surface repair timing, etc.,) is generated based on the obtained damage and the determined run-through ability of each movable body V. An optimum solution of the traveling plan (the traveling order, the road surface repair timing, etc.,) is obtained based on the estimated road surface condition and the determined run-through ability of each movable body V, on the premise that a predetermined amount of work (such as traveling of the predetermined number of the movable bodies V) is completed within a predetermined set time. The optimum solution may be obtained according to a method widely used in the logistics industry, for instance.

In the present embodiment, the small-sized movable body LV travels so as to precede the mid-sized movable body MV and the large-sized movable body HV. Thus, many movable bodies V can travel in a state in which the cumulative value of the damage of the road surface is small. It is accordingly possible to reduce the frequency of the road surface repair, resulting in improved work efficiency.

Further, the movable body V is less likely to get stuck in the travel region, so that the plurality of movable bodies V travels smoothly.

Moreover, because the traveling plan is generated based on the road surface condition and the run-through ability, the road surface repair timing can be properly determined.

As illustrated in FIG. 9, traveling of the large-sized movable body HV may be prohibited (limited) until a set time Tc elapses after the event such as water sprinkling, rainfall or the like occurs (T5). If the large-sized movable body HV travels in a state in which the damage of the road surface due to water sprinkling, rainfall or the like is great, the deterioration gradient of the road surface condition increases. In view of this, the large-sized movable body HV is prohibited from traveling until the set time Tc elapses after the occurrence of the event. In the present embodiment, the large-sized movable body HV is the movable body having the weight greater than the first set weight, which is a weight threshold described in the appended claims. The large-sized movable body HV causes the damage to the road surface greater than a set level and has the run-through ability greater than a set ability.

When the set time Tc elapses after the occurrence of water sprinkling or rainfall, the road surface becomes dry and the damage of the road surface becomes small. In this case, the large-sized movable body HV may be allowed to travel. The set time Tc may be a time that is estimated to be required for the road surface to substantially dry after the event, for instance. The set time Tc may be a predetermined time or may be a time determined based on meteorological information after the occurrence of the event such as water sprinkling, rainfall, or the like. In the former case, the set time Tc may be determined beforehand based on weather forecasting. The traveling plan is generated in consideration of the occurrence of the event and the set time Tc.

The meteorological information includes temperature, humidity, and a wind speed, for instance. The set time Tc can be made shorter when the temperature is high, when the humidity is low, or when the wind speed is high (when the wind volume is great) after the occurrence of the event (e.g., after water sprinkling is completed or after rain stops) than when the temperature is low, when the humidity is high, or when the wind speed is low (when the wind volume is small) after the occurrence of the event.

The work plan generating portion 50 executes a set time determining routine of a flowchart of FIG. 10. This routine is part of the work plan generating program.

At S11, it is determined whether water sprinkling as one example of the event is performed. When an affirmative determination YES is made, the control flow proceeds to S12 at which information on the weather forecasting is transmitted from an external information transmitting device and received and obtained by the control communication device 42. At S13, the set time Tc is determined based on the forecast meteorological information. The traveling plan is generated such that the large-sized movable body HV is prohibited from traveling until the set time Tc elapses after water sprinkling is performed.

In the embodiment illustrated above, the work plan generating portion 50 corresponds to a work plan generating device, for instance. The work plan generating portion 50 may be considered as a traveling control device.

Based on the meteorological information (including the forecast meteorological information) after the occurrence of the event, the condition of the water content of the road surface may be estimated, so that the magnitude of the damage to the road surface caused by one movable body V and the run-through ability of each movable body V may be determined. As illustrated in FIGS. 11 and 12, as the road surface becomes dry, the run-through ability and the damage to the road surface caused by one movable body V return to respective levels before the occurrence of the event. That is, the run-through ability increases, and the magnitude of the damage to the road surface caused by one movable body V decreases.

The recovery speeds of the run-through ability and the magnitude of the damage to the road surface are also determined based on the meteorological information. When the temperature is high, when the humidity is low, or when the wind speed is high, the recovery speeds are higher than when the temperature is low, when the humidity is high, or when the wind speed is low.

For instance, the run-through ability and the magnitude of the damage to the road surface caused by one movable body may be changed for the set time Tc continuously or in steps depending on the degree of dryness of the road surface.

The road surface unevenness condition, which is one example of the road surface condition, may be estimated by cumulating the damage to the road surface caused by one movable body V without estimating the water content of the road surface.

### Second Embodiment

The central control device S is not essential as illustrated in FIGS. 13 and 14. As illustrated in FIG. 14, each movable body Vc includes a surroundings information obtaining device 12c, a movable body communication device 14c, a movable body ECU 20c, a GPS receiver 10c, a drive device Dc, a brake device Bc, a steering device Tc, and road surface sensors 70c. The movable body ECU 20c includes a run-through possibility determining portion 72c, in addition to an identification information storage portion 22c, a movable body information generating portion 24c, and a traveling control portion 26c. The movable body communication device 14c, the GPS receiver 10c, the drive device Dc, the brake device Bc, the steering device Tc, the identification information storage portion 22c, and the traveling control portion 26c are similar to those in the first embodiment, a detailed explanation of which is dispensed with.

The surroundings information obtaining device 12c obtains the road surface unevenness condition around an own movable body Vc based on images taken by cameras.

Each road surface sensor 70c is installed on a tire of the corresponding wheel 28 and obtains humidity of the road surface (the water content of the road surface) , for instance. The condition of the road surface detected by the road surface sensor 70c is transmitted to the vehicle body side and received by the movable body communication device 14c, via a communication device (e.g., a communication device of the road surface sensor 70c or a communication device provided on the tire separately from the road surface sensor 70c).

The run-through possibility determining portion 72c determines whether the own movable body Vc can run through the travel region located ahead of the own movable body Vc based on the run-through ability of the own movable body Vc and the road surface condition of the travel region located ahead of the own movable body Vc.

The movable body information generating portion 24c generates movable body information including movable body positional information indicative of the position of the own movable body Vc and road surface condition information indicative of the road surface condition of a travel region P to be traveled by the own movable body Vc.

As illustrated in FIG. 13, for instance, an own movable body Vcy receives the movable body information transmitted from a preceding movable body Vcx that travels ahead of the own movable body Vcy and obtains the road surface condition of a travel region Px where the movable body Vcx that travels ahead of the own movable body Vcy is located.

The own movable body Vcy determines whether it can run through the travel region Px based on the road surface condition of the travel region Px and the run-through ability of the own movable body Vcy. When it is determined that the own movable body Vcy can run through the travel region Px, the own movable body Vcy travels the travel region Px ahead of the own movable body Vcy. When it is determined that the own movable body Vcy cannot run through the travel region Px, the own movable body Vcy stops before the travel region Px or detours the travel region Px by controlling the brake device B or the steering device Tc.

Also in the present embodiment, the movable body Vcy is less likely to get stuck in the travel region Px.

In the present embodiment, the run-through possibility determining portion 72c, the traveling control portion 26c, etc., constitute a traveling control device, and the traveling control device, the movable body communication device 14c, the movable body information generating portion 24c, etc., constitute a traveling control system.

The road surface condition and the meteorological information may be transmitted from an external information transmitting device (not illustrated). In this instance, the movable body information may include damage information which is determined for the movable body Vcx and which indicates the magnitude of the damage to the road surface caused by the movable body Vcx. The movable body Vcy can obtain the road surface condition of the travel region Px where the own movable body Vcy is to travel based on the road surface condition of the travel region Px transmitted from the external information transmitting device, the meteorological information, and the damage to the road surface caused by the movable body Vcx. The movable body Vcy determines whether the own movable body Vcy can run through the travel region Px.

The movable body Vcy may determine whether it can run through the travel region ahead of the movable body Vcy based on the road surface condition ahead of the movable body Vcy obtained by the surroundings information obtaining device 12 and the run-through ability of the own movable body Vcy. When a negative determination NO is made, for instance, the own movable body Vcy travels so as to detour the travel region ahead of the own movable body Vcy. When an affirmative determination YES is made, for instance, the drive device Dc of the own movable body Vcy is controlled such that the own movable body Vcy travels the travel region ahead of the own movable body Vcy.

It is to be understood that the present disclosure may be embodied with various changes and modifications, which may occur to those skilled in the art.

### Claimable Invention

There will be hereinafter described forms of a claimable invention.

(1) A management system configured to manage a plurality of movable bodies that travels a travel region, including: a work plan generating device configured to generate a work plan of the plurality of movable bodies based on a run-through ability of each of the plurality of movable bodies and a road surface condition that is a condition of a road surface of the travel region.

The work plan generating device of this form generates the traveling plan in the work plan. The work plan may be generated so as to allow as many movable bodies as possible to run through the travel region.

(2) The management system according to the form (1), wherein the work plan generating device obtains the road surface condition of the travel region by cumulating damage to the road surface caused by traveling of each of the movable bodies.

The road surface condition of this form may be considered as the road surface unevenness condition or as a condition including the road surface unevenness condition and the condition relating to the water content of the road surface.

Here, a case is considered in which the magnitude of the damage to the road surface caused by traveling of each movable body is determined based on the condition relating to the water content of the road surface (the condition in which the road surface is dry and the condition in which the road surface is wet). In this case, when the road surface unevenness condition is estimated by cumulating the damage to the road surface caused by traveling of each movable body, the condition relating to the water content of the road surface is also estimated.

(3) The management system according to the form (2), wherein the damage to the road surface caused by the traveling of each of the movable bodies is determined to be a greater value when a weight of each of the movable bodies is great than when the weight is small, and wherein the damage to the road surface caused by the traveling of each of the movable bodies is determined to be a greater value when a water content of the road surface is great than when the water content is small.

The damage to the road surface caused by traveling of each movable body is determined to be a greater value when the weight of the movable body is greater than the set weight than when the weight of the movable body is not greater than the set weight. The damage to the road surface caused by traveling of each movable body is determined to be a greater value when the water content of the road surface is greater than the set content than when the water content of the road surface is not greater than the set content. It is preferable to determine that the damage to the road surface caused by traveling of each movable body be predetermined based on at least one of the weight of the movable body and the condition relating to the water content of the road surface.

(4) The management system according to any one of the forms (1)-(3), wherein the run-through ability of each of the movable bodies is determined to be a higher value when a weight of each of the movable bodies is greater than a set weight than when the weight is not greater than the set weight, and wherein the run-through ability of each of the movable bodies is determined to be a higher value when a friction coefficient of the road surface is higher than a set value than when the friction coefficient is not higher than the set value.

The run-through ability of the movable body is higher when the weight of the movable body is greater than the set weight than when the weight of the movable body is not greater than the set weight. The run-through ability of the movable body is higher when the friction coefficient of the road surface is higher than a set value than when the friction coefficient of the road surface is not higher than the set value. When the water content of the road surface is great, the friction coefficient of the road surface is usually low.

(5) The management system according to any one of the forms (1)-(4), wherein the work plan generating device determines a traveling order of the plurality of movable bodies such that the run-through ability of each of the movable bodies is higher than the run-through ability required based on the road surface condition.

The run-through ability is represented as the road surface condition that can be run through. Thus, in a case where the run-through ability is higher than the run-through ability based on the road surface condition, it is considered that the movable body can run through the travel region. For instance, the traveling (departure) order may be determined such that the movable body with lower run-through ability starts earlier than the movable body with higher run-through ability.

In other words, the traveling order may be determined such that the movable body with lower run-through ability travels the travel region so as to precede the movable body with higher run-through ability. Further, the traveling order may be determined such that the movable body that causes smaller damage to the road surface travels so as to precede the movable body that causes larger damage to the road surface.

(6) The management system according to any one of the forms (1)-(5), wherein the work plan generating device determines a traveling order of the plurality of movable bodies in a state in which the run-through ability of each of the movable bodies is not excessive with respect to the road surface condition.

(7) The management system according to any one of the forms (1)-(6), wherein the work plan generating device determines a traveling order of the plurality of movable bodies in a state in which a margin of the run-through ability of each of the movable bodies with respect to the run-through ability required based on the road surface condition is smaller than a set margin.

(8) The management system according to any one of the forms (1)-(7), wherein the plurality of movable bodies includes a first movable body and a second movable body whose weight is greater than the first movable body, and wherein the work plan generating device determines a traveling order of the plurality of movable bodies in a state in which the first movable body travels so as to precede the second movable body.

It may be considered that the first movable body corresponds to the small-sized movable body and the second movable body corresponds to the mid-sized movable body or the large-sized movable body. It may be considered that the first movable body corresponds to the small-sized movable body or the mid-sized movable body and the second movable body corresponds to the large-sized movable body.

(9) The management system according to any one of the forms (1)-(8), wherein the work plan generating device generates the work plan such that a repair of the road surface is performed when it is estimated that at least one of the plurality of movable bodies is incapable of running through the travel region before a work of a predetermined work amount is completed.

The work plan is usually generated on the premise that a predetermined amount of work is completed within the predetermined set time, namely, on the premise that traveling of the plurality of movable bodies is completed within the predetermined set time.

(10) The management system according to any one of the forms (1)-(9), wherein the work plan generating device generates the work plan such that a repair of the road surface is performed when it is required that the predetermined number or more of the movable bodies travel in a set time before a work of a predetermined work amount is completed.

The road surface repair condition may be a condition satisfied when the run-through ability of at least one of the plurality of movable bodies is lower than the run-through ability based on the road surface condition at that time point or may be a condition satisfied when high workability is required.

(11) The management system according to any one of the forms (1)-(10), wherein damage to the road surface caused by traveling of each of the movable bodies is determined to be a greater value when an event occurs than when the event does not occur.

(12) The management system according to any one of the forms (1)-(11), wherein the run-through ability of each of the movable bodies is determined to be a smaller value when an event occurs than when the event does not occur.

(13) The management system according to the form (11) or (12), wherein the event is one of rainfall, snowfall, and water sprinkling.

The occurrence of rainfall or snowfall is estimated based on the meteorological information that is forecast. In any case, the water content of the road surface is greater and the road surface becomes wet when the events occurs than before the event occurs.

(14) The management system according to any one of the forms (1)-(13), wherein the run-through ability after occurrence of an event is obtained based on meteorological information after occurrence of the event.

The degree of dryness of the road surface after rainfall, snowfall, or water sprinkling is determined based on the meteorological information (the weather forecasting).

Further, the magnitude of the damage to the road surface caused by each movable body after the occurrence of the event and the run-through ability of each movable body after the occurrence of the event are determined based on the degree of dryness of the road surface. Accordingly, it may be considered that the magnitude of the damage to the road surface caused by each movable body after the occurrence of the event and the run-through ability of each movable body after the occurrence of the event are determined based on the meteorological information.

For instance, the magnitude of the damage to the road surface caused by each movable body and the run-through ability of each movable body recover to respective levels before the occurrence of the event as the road surface becomes dry. The recovery speed in this instance is higher when the temperature is high, when the humidity is low, or when the wind speed is high than when the temperature is low, when the humidity is high, or when the wind speed is low.

(15) The management system according to any one of the forms (1)-(14), wherein the work plan generating device generates the work plan so as to limit traveling of the movable body having a weight greater than a weight threshold until a set time elapses after occurrence of an event.

The set time may be a predetermined set time or may be a time determined based on the meteorological information. In the latter case, the set time may be determined based on information of weather forecasting or may be determined as necessary based on actual meteorological information after the occurrence of the event. In a case where the set time is predetermined, the timing at which water sprinkling is performed is determined and the work plan is generated in consideration of the limitation of traveling of the movable body with a greater weight than the set weight for the set time after the occurrence of the event.

The weight threshold may be the first set weight or the second set weight in the illustrated embodiment or may be a value other than these values.

The set time may be a shorter time when the temperature is high, when the humidity is low, or when the wind speed is high than when the temperature is low, when the humidity is high, or when the wind speed is low. This reduces a time for recovery of the damage to the road surface by each movable body to the level before the occurrence of the event and a time for recovery of the run-through ability to the level before the occurrence of the event.

(16) A traveling control system configured to control traveling of a movable body, including a traveling control device configured to cause the movable body not to travel a travel region located ahead of the movable body when it is determined that the movable body is incapable of running through the travel region based on a run-through ability of the movable body and a road surface condition of the travel region.

The movable body may stop before the travel region or may detour the travel region.

The traveling control system of this form may employ the technical feature of any one of the forms (1)-(15).

(17) The traveling control system according to the form (16), wherein the traveling control device obtains the road surface condition of the travel region located ahead of an own movable body as the movable body based on: a road surface condition before a preceding movable body, which is the movable body travelling ahead of the own movable body, travels the travel region; and damage to the road surface caused by traveling of the preceding movable body.

What is claimed is:

1. A management system configured to manage a plurality of movable bodies that travels a travel region, comprising a work plan generating device configured to generate a work plan of the plurality of movable bodies based on a run-through ability of each of the plurality of movable bodies and a road surface condition that is a condition of a road surface of the travel region.

2. The management system according to claim 1, wherein the work plan generating device determines a traveling order of the plurality of movable bodies such that the run-through ability of each of the movable bodies is higher than the run-through ability required based on the road surface condition.

3. The management system according to claim 1, wherein the work plan generating device determines a traveling order of the plurality of movable bodies in a state in which a margin of the run-through ability of each of the movable bodies with respect to the run-through ability required based on the road surface condition is smaller than a set margin.

4. The management system according to claim 1,
wherein the plurality of movable bodies includes a first movable body and a second movable body whose weight is greater than the first movable body, and
wherein the work plan generating device determines a traveling order of the plurality of movable bodies in a state in which the first movable body travels so as to precede the second movable body.

5. The management system according to claim 1, wherein the work plan generating device generates the work plan such that a repair of the road surface is performed when it is estimated that at least one of the plurality of movable bodies is incapable of running through the travel region before a work of a predetermined work amount is completed.

6. The management system according to claim 1, wherein the work plan generating device generates the work plan such that a repair of the road surface is performed when it is required that the predetermined number or more of the movable bodies travel in a set time before a work of a predetermined work amount is completed.

7. The management system according to claim 1, wherein the work plan generating device obtains the road surface condition of the travel region by cumulating damage to the road surface caused by traveling of each of the movable bodies.

8. The management system according to claim 1, wherein damage to the road surface caused by traveling of each of the movable bodies is determined to be a greater value when an event occurs than when the event does not occur.

9. The management system according to claim 1, wherein the run-through ability of each of the movable bodies is determined to be a smaller value when an event occurs than when the event does not occur.

10. The management system according to claim 8, wherein the event is one of rainfall, snowfall, and water sprinkling.

11. The management system according to claim 8, wherein the run-through ability after occurrence of the event is obtained based on meteorological information after occurrence of the event.

12. The management system according to claim 1, wherein the work plan generating device generates the work plan so as to limit traveling of the movable body having a weight greater than a weight threshold until a set time elapses after occurrence of an event.

13. The management system according to claim 1,
wherein the work plan generating device obtains the road surface condition of the travel region by cumulating damage to the road surface caused by traveling of each of the movable bodies,
wherein the work plan generating device determines a traveling order of the plurality of movable bodies such that the run-through ability of each of the movable bodies is higher than the run-through ability required based on the road surface condition, and
wherein (i) damage to the road surface caused by traveling of each of the movable bodies is determined to be a greater value when an event occurs than when the event does not occur and (ii) the run-through ability of each of the movable bodies is determined to be a smaller value when an event occurs than when the event does not occur.

14. A traveling control system configured to control traveling of a movable body, comprising:
a traveling control device configured to cause the movable body not to travel a travel region located ahead of the movable body when it is determined that the movable body is incapable of running through the travel region based on a run-through ability of the movable body and a road surface condition of the travel region.
